(19) United States
(12) Patent Application Publication
(10) Pub. No.: US 2004/0057376 A1
(43) Pub. Date: Mar. 25, 2004

(54) Communications system

(76) Inventors: Gyorgy Sasvari, Cranberry, PA (US); Paul L Colleit, Sturminster (GB)

Correspondence Address: Kirschstein Ottinger, Israel & Schiffmiller, 489 Fifth Avenue, New York, NY, 10017, US

(21) Appl. No.: 10/203,392

(22) PCT Filed: Jan. 22, 2001
(86) PCT No.: PCT/GB01/00217

(30) Foreign Application Priority Data
Feb. 8, 2000 (GB) 002731.8

(51) Int. Cl. H04L 12/26

(52) U.S. Cl. 370/230; 370/468; 370/252

(57) ABSTRACT

A communications system with a finite bandwidth for the communication of traffic of a plurality of users comprising policing means for monitoring the bandwidth use of each of the users, the policing means comprising bandwidth use averaging means implemented in hardware, the policing means also comprising packet discard means for discarding packets in a pseudo-random fashion.

The present invention is related to the field of communications in general and to the policing of communications traffic in particular.

In a typical data communications network, for example a packet-based Internet protocol (IP Network), any one link may carry packets from a multitude of users at any one time. Whereas the overall link bandwidth is fixed, the bandwidth occupied by traffic from any particular user may vary greatly with time. Traffic with such a time-varying bandwidth usage is referred to as “bursty”. During a burst, traffic from a particular user may occupy the full bandwidth of the link, whereas between bursts that user may use little or no bandwidth. This is a direct result of the nature of many applications using data communications networks and is complicated by messages being divided into packets which may follow diverse routes through a communications network, each route introducing a different amount of delay. Hence the distribution over time of packets from a particular user arriving at a particular point in the network may be very wide.

In a typical communications network, each user will be allocated a set bandwidth for their use. It is the job of the network management system to ensure that users do not exceed their allocated bandwidth limit. The policing of bandwidth use by the users in IP networks is typically carried out in a so-called firewall. This is a node that acts at the boundary between a secure and an insecure part of the network. However, the bursty nature of much user traffic presents a problem to the management system in trying to measure bandwidth used over time.

A method of bandwidth use control common in asynchronous transfer mode communications networks is the “leaky bucket”, however this is designed for use with essentially constant traffic levels from each user. If applied to a system with large variations in traffic level (bandwidth use) per user the “bucket” might quickly empty during a burst resulting in severe reduction in service to the user, even though their average bandwidth use was well within the level allocated.

The present invention provides a communications system for the communication of traffic of a plurality of users in which the system has a finite bandwidth for carrying the traffic; in which the system comprises policing means for monitoring the bandwidth use of each of the users; in which the policing means comprises bandwidth use averaging means implemented in hardware for calculating an average value of bandwidth use per user.

According to a preferred embodiment, the present invention provides a communications system in which the policing means comprises packet discard means for discarding packets in a pseudo-random fashion.

The present invention also provides a method of policing bandwidth use in a communications system for the communication of traffic of a plurality of users in which the system has a finite bandwidth for carrying the traffic; the method including the steps of monitoring the bandwidth use of each of the users and generating in hardware an average value of bandwidth use per user.

According to a preferred embodiment, the present invention provides a method of policing bandwidth including the steps of recording the history of bandwidth use by each user and discarding packets in a pseudo-random fashion; in which the probability that a packet of a particular user will be discarded depends on the history of bandwidth use by the user

The present invention also provides a communications system for the communication of traffic of a plurality of users in which the system has a finite bandwidth for carrying the traffic; in which the system comprises policing means for monitoring the bandwidth use of each of the users; in which the policing means comprises packet discard means for discarding packets in a pseudo-random fashion.

The present invention also provides a communications system for the communication of traffic of a plurality of users in which the system has a finite bandwidth for carrying the traffic; in which the system comprises policing means for monitoring the bandwidth use of each of the users; in which the policing means comprises packet discard means for discarding packets on an individual basis.

The present invention also provides a method of policing bandwidth use in a communications system for the communication of traffic of a plurality of users in which the system has a finite bandwidth for carrying the traffic; the method including the steps of monitoring the bandwidth use of each of the users and discarding packets in a pseudo-random fashion.

Embodiments of the present invention will now be described by way of example with reference to drawings in which

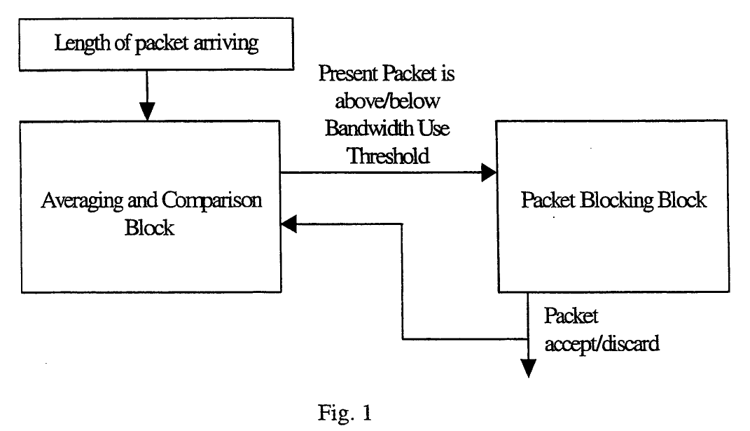

FIG. 1 shows, in block diagram form, a bandwidth policing system according to the present invention;

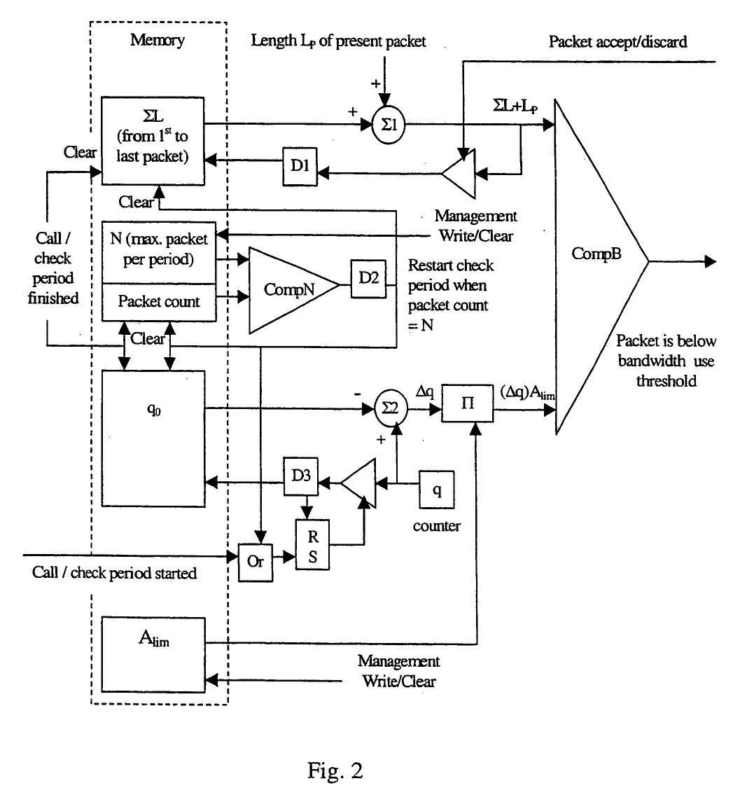

FIGS. 2 to 5 show embodiments of the averaging and comparison block of FIG. 1 in more detail;

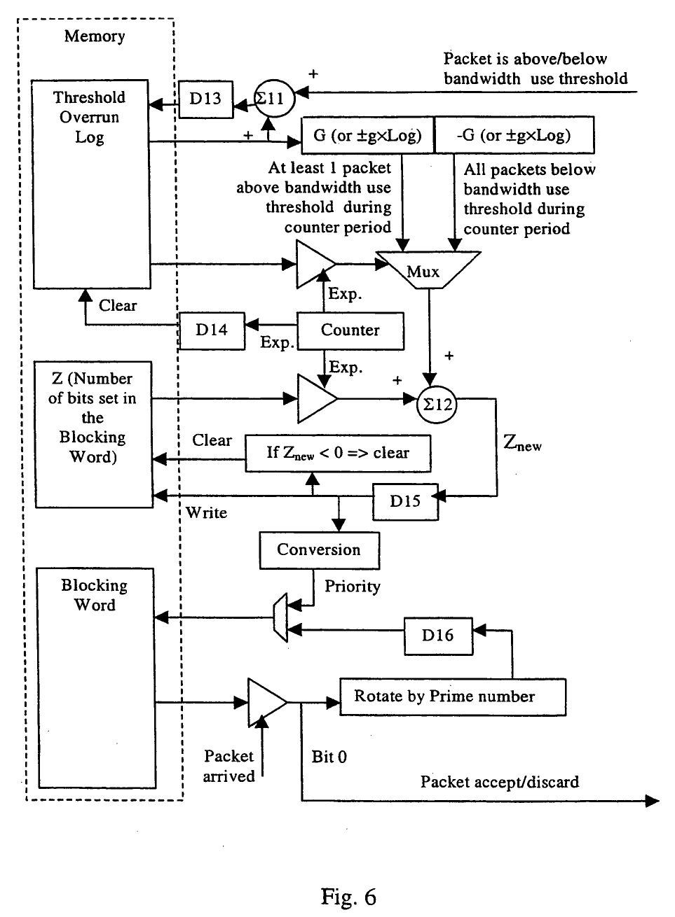

FIG. 6 shows an embodiment of the packet blocking block of FIG. 1 in more detail.

FIG. 1 shows a system for policing bandwidth use in a packet-based communications system. The system is based on an averaging and comparison block for measuring bandwidth use and comparing it with the set threshold, and a packet blocking block for deciding which packets to block or when to block packets. The lengths of arriving packets are provided to the averaging and comparison block which sends an indication to the packet blocking block as to whether the bandwidth use threshold has been exceeded. The packet blocking block returns an indication as to whether blocking is active and also generates an output indicating the same.

1. Arithmetic Average

Instantaneous bandwidth use B is defined as the total number of bytes dW accepted by a node (as explained below) from the user per unit time dt. Instantaneous bandwidth use B and total number of bytes accepted dW may be expressed as follows:

$$\begin{matrix}B = \frac{ⅆ W}{ⅆ t} \\ d W = {\sum }_{i = 1}^{n} {L}_{i}\end{matrix}$$

where Lᵢ is the total length in bytes of the ith packet accepted with i=1,2, . . . n. Lᵢ is defined as the first packet accepted at or after time t and Lₙ is defined as the last packet accepted before time t+dt. The header of a packet is easy to identify and, in practice, it is convenient to take the decision to accept or reject a packet on receipt of its header, i.e. at the start of a packet. As the header contains a count of the number of bytes in the packet, this count is advantageously used to provide the value of W.

The average bandwidth A used by a particular user may be defined as the average over a set k of m values of instantaneous user bandwidths B. The value of A may be calculated by summing each value of dW over time period mdt, and dividing the resultant sum by the total time period mdt. Hence A may be expressed as follows:

$$A = \frac{{\sum }_{k = 1}^{m} {B}_{k}}{m} = \frac{{\sum }_{k = 1}^{m} ⅆ {W}_{k}}{m ⅆ t} .$$

For implementation in hardware of a circuit for generating A, the sum of bytes ΣW maps to the sum of the packet lengths ΣL, in bytes, accepted from the user during a check period T. T is equal to (q−q₀)dτ, where dτ is the period of a clock signal and q₀ and q are initial and final count values, respectively, of an internal counter for counting the clock periods. The value of q is generated by a free-running non-over-rolling counter; time being measured by incrementing the count q each clock period dτ. By non-over-rolling is meant that the counter comprises enough bits not to reach maximum count and roll-over to zero during the lifetime of the product. By way of example, if the q counter is 55 bits long and incremented each dτ, i.e. each clock period, and if each clock period is set to 32 ns, say, roll-over will only happen after approximately 36 years, so the management system can clear the sum and record of q₀ at any convenient time, e.g. at the close of a call from the user in question. In the following, the count value is taken to be synonymous with the corresponding time period based on the clock period dτ. This mapping may be expressed as follows:

$${\sum }_{k = 1}^{m} d {W}_{k} ↦ {\sum }_{t = {q}_{0} d τ}^{q d τ} {L}_{accepted} .$$

A comparison may then be performed between the sum of the measured value of instantaneous bandwidth use B (as indicated by the sum of L described above) and the allowed bandwidth use derived from the product of the imposed limit for average bandwidth Aₗᵢₘ and the length of the measurement period T, as follows:

$${\sum }_{t = {q}_{0} d τ}^{q d τ} {L}_{accepted} {=}_{compare} ( q - {q}_{0} ) {A}_{l im} . \qquad ( Eq . 1 )$$

The value of Aₗᵢₘ is set by the management system. The above comparison (i.e. ΣL:(q−q₀) Aₗᵢₘ) may be carried out either on a time basis (i.e. after a set count of clock periods q) or per packet transfer. If the present packet pushes the ΣL value above the bandwidth threshold (i.e. ΣL>(q−q₀)Aₗᵢₘ) the present packet may be discarded. If the average bandwidth use A is equal to or less than the threshold value Aₗᵢₘ, the packet is accepted and ΣL, q₀, and A are stored with a user identifier. ΣL and q₀ are updated by the hardware only on acceptance of a packet or under control of the management system. According to the present invention, the steps required to check bandwidth use, as described above, are advantageously implemented in hardware allowing efficient calculation of B (i.e. by summation of L) in a small number of clock cycles and reducing the software processing load.

FIG. 2 shows an embodiment of the averaging and comparison block of FIG. 1 suitable for implementation in hardware. This embodiment is based on equation Eq.1, above. When a packet arrives its length L_{P} is detected and “Length L_{P} of present packet” is added in summer Σl to the sum ΣL (read from memory) of previous packet lengths received since the check period started. After this, this new sum ΣL+L_{P} is transmitted to the comparator “CompB” and also written back to the same memory location as the previous accumulated packet lengths ΣL were stored in.

If adaptive (i.e. variable) periods are used, the maximum packet count N is set in the memory, and a “Packet count” is implemented in the memory. When the two are equal (i.e. the packet count reaches N) then, after a delay D2, the comparator “CompN” (e.g. bitwise XOR) clears the Packet count, the memory location holding ΣL and the timer counter value q₀ (corresponding to the start of the period) also held in memory. Thus the circuit is returned to an initial state corresponding to the start of a new checking period.

When a new check period starts, the initial value q₀ of the timer counter q for the new checking period is written into memory. Further writes to this memory location are inhibited until the start of the next check period. In the Figure this disabling is shown as an RS storage element controlling enable logic (triangle) positioned between the counter q and a delay element D3 connected to provide the counter value q to the memory and to the reset (R) input of the RS element. The set (S) input of the RS element is activated by the output of an OR gate that has two inputs. A first input is provided via a delay D2 by the detection by CompN of the Nth packet; the second input is provided by network management on call/session setup via signal “call/check period started”. When the RS element is set, i.e. after a signal to the S input, the enable logic (triangle) is enabled. After a signal is applied to the R input, the enable logic (triangle) is disabled. The RS element may be implemented as a D-type with suitable feedback. The RS block enables the write of q after the start of the call/check period and disables the write after the counter value q of the first packet of the period has been written into memory. The counter is long enough not to overroll in the product lifetime (e.g. 2⁶⁴×32 ns).

The memory also holds the allocated bandwidth use threshold Aₗᵢₘ, set by the management system.

When a packet arrives the counter value q₀ (i.e. indicating the time when the current checking period started) is read from the memory and subtracted from the current counter value q in summer Σ2. This difference Δq=q−q₀ is then multiplied by Aₗᵢₘ in multiplier Π and the product Δq. Aₗᵢₘ compared in comparator Comp B to the new sum of the packet lengths ΣL+L_{P}. If ΣL+L_{P} is less than or equal to the threshold value (Δq)Aₗᵢₘ then the present packet has not caused the bandwidth use threshold to be exceeded.. The comparator produces an output indicating the result of the comparison (i.e. whether the present packet is above or below the bandwidth use threshold) which is provided to the packet blocking block of FIG. 1.

2. Interarrival Time

If summing of instantaneous values of bandwidth use B is not essential, we can eliminate the byte count W by noting the arrival time of the last packet qₗₐₛₜ and the arrival time of the present packet qₚᵣₑₛ, calculating the corresponding allowed bandwidth use over this period and comparing it with the length L of the last packet, as follows:

$$L ( last . packet ) {=}_{compare} ( {q}_{pres} - {q}_{last} ) {A}_{l im} , \qquad ( Eq . 2 )$$

with the time measured by incrementing the count q each dτ (as above).

This comparison is only performed on the arrival of a packet at the node. A single time-period counter is used (i.e. similar to Eq 1) with the count value q being read at the arrival of each new packet. The present packet is judged to have pushed the average bandwidth use A above the bandwidth use threshold Aₗᵢₘ when L exceeds (qₚᵣₑₛ−qₗₐₛₜ)Aₗᵢₘ. This could be expressed as the present packet arriving “too soon”. The values of L, qₗₐₛₜ, and Aₗᵢₘ are stored with the user identifier. The values of L and qₗₐₛₜ are updated by the hardware only on acceptance of a packet or by the management system. Advantageously, this method is particularly suitable for real-time voice or video (both compressed or uncompressed) where real-time packets of the same connection/call/session follow each other fairly regularly (say in every 20 msec): if this was not the case the speech and video would get corrupted. If a sudden increase in bandwidth use occurs, i.e. a large number of packets or longer packets suddenly arrive from the user, it means that further speech/video transactions have been added to the existing connection/call/session. The extra traffic will be blocked if the bandwidth negotiated for with the management system is exceeded, and/or no extra free network bandwidth exists.

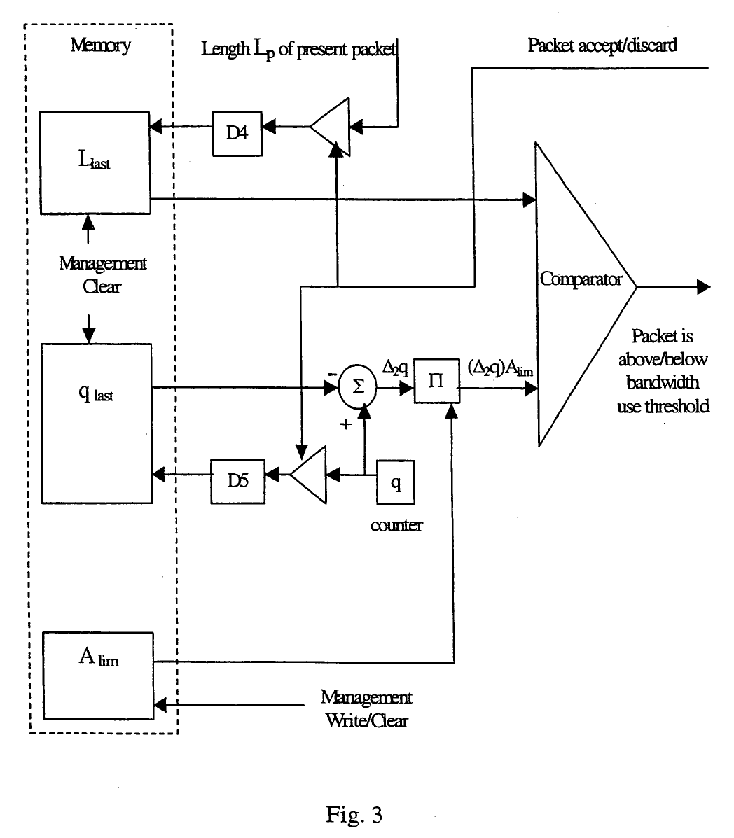

FIG. 3 shows an alternative embodiment of the averaging and comparison block of FIG. 1 suitable for implementation in hardware. This embodiment is based on equation Eq.2.

When a packet arrives, the length Lₗₐₛₜ of the previously accepted packet and the counter value qₗₐₛₜ corresponding to the arrival of time of the previously accepted packet are read from the memory. The counter value qₗₐₛₜ is subtracted in summer Σ from the counter value q_{P} corresponding to the arrival time of the present packet. The difference Δ₂q between these counter values is then multiplied in multiplier Π by the allocated bandwidth use figure Aₗᵢₘ read from memory and the product Δ₂q.Aₗᵢₘ compared by the comparator with the length Lₗₐₛₜ of the last accepted packet. If Lₗₐₛₜ is less than the product (Δ₂q)Aₗᵢₘ then the bandwidth use so far in the current check period is below the bandwidth threshold Aₗᵢₘ. The comparator produces an output indicating the result of the comparison (i.e. whether the present packet is above or below the bandwidth use threshold) which is provided to the packet blocking block of FIG. 1.

The “packet accept/discard” signal generated by the packet blocking block of FIG. 1 controls the operation of two enable gates (triangles). If this signal indicates the packet is to be accepted then the length Lₗₐₛₜ of the last packet and the counter value corresponding to the arrival time of the last packet are overwritten (after delays D4 and D5, respectively). by the length L_{P} of the present packet and the counter value q_{P} corresponding to the arrival time of the present packet passed by the respective enable gates.

3. Smoothed Average

Alternatively, a new smoothed average method is proposed. According to one method, the smoothed average is given by the smoothing factor ay according to

$${R}_{new} = α {R}_{old} + ( 1 - α ) \frac{L}{t - {t}_{last}}$$

where α is close to, but less than, unity and typically lies in the range from 0.8 to 0.95, R_{new} and R_{old} are the new and previously measured data rates respectively, t and tₗₐₛₜ are the present time and the time of the previous measurement (i.e. the arrival time of the previous packet) respectively, and L is the number of bytes of the present packet. However this method is difficult to implement in hardware due to the need to divide a variable by a variable.

Advantageously, according to a preferred embodiment of the present invention, a new method is proposed using a constant divider T (measurement period) in place of the variable t−tₗₐₛₜ , as follows:

$${R}_{new} = α {R}_{old} + ( 1 - α ) \frac{{\sum }_{t = 0}^{T} {L}_{t}}{T}$$

As can bee seen from the above formula, the new rate is calculated in relation to the sum of all the packet lengths L accepted during the constant time period T. This is advantageously simpler and cheaper to implement in hardware since the recording of time is not needed, and the calculation can be implemented by simple binary multiplication/addition: no complex divider logic is required, the only division being achieved by ignoring some of the least significant bits, i.e. by effectively decreasing the significance of each bit of the quantity to be divided (as described below).

For simplicity α may be assigned to a value of c/2ⁿ (where ‘c’ is close to but slightly less than 2ⁿ) and T may be assigned to a value of 2^{m}τ, where τ is the clock period. The equation now translates to the following expression:

$${R}_{new} = c \times {R}_{old} / {2}^{n} + ( {2}^{n} - c ) \times ( {\sum }_{t = 0}^{T} {L}_{t} ) / {2}^{n} \qquad ( Eq . 3 )$$

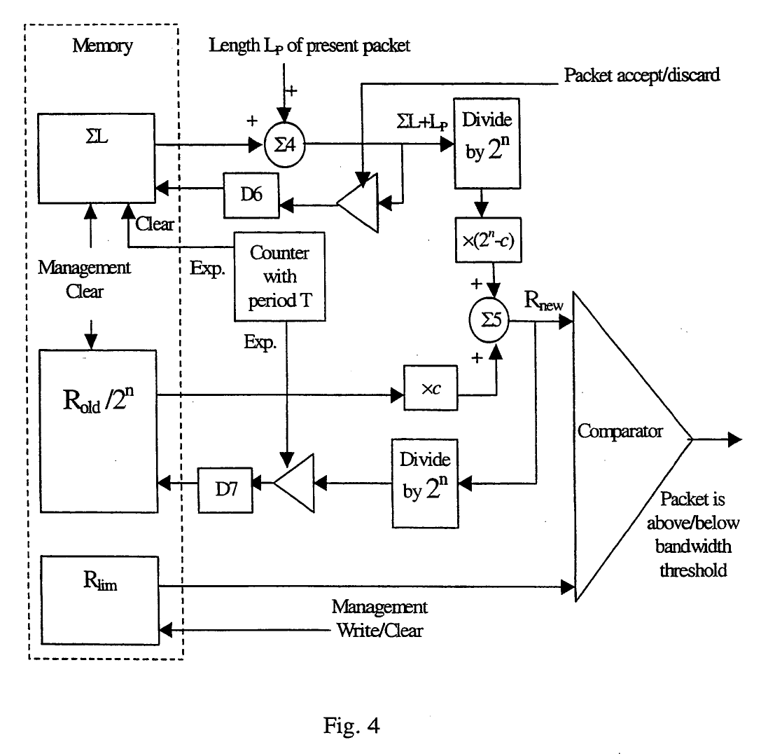

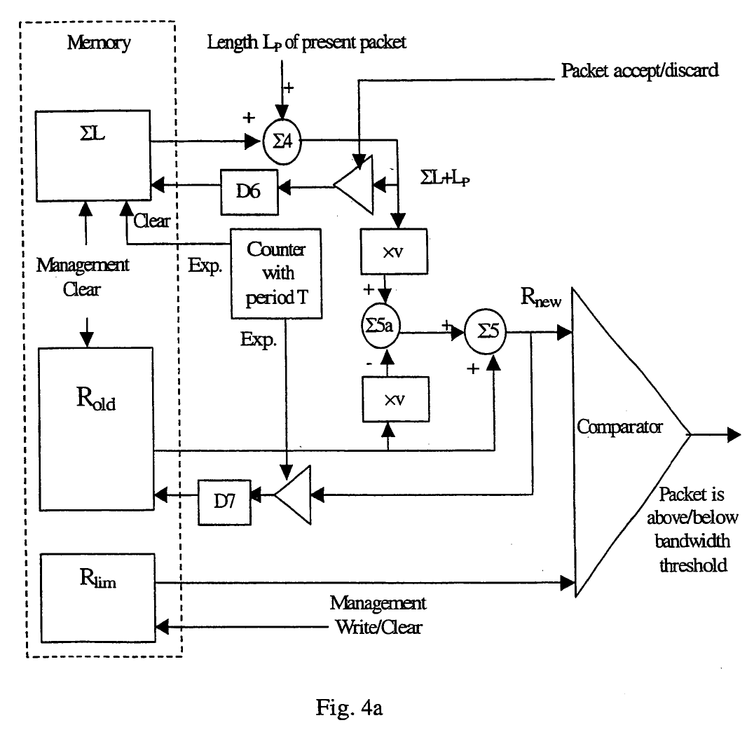

This can be implemented in hardware, as shown in FIG. 4, with two multipliers and two adders, and division by 2ⁿ (simply implemented by discounting the lowest n bits) in two places. Only the old rate R_{old} and the accumulated length ΣL have to be stored for the above calculation. These values will be stored indexed/addressed by the User identifier. A threshold rate (Rₗᵢₘ.)for policing is defined by the management system. The cumulated length ΣL has to be cleared on every rate update (i.e. every time period T). The present packet is judged to cause a violation of the bandwidth use threshold when R_{new} exceeds Rₗᵢₘ.

FIG. 4 shows a further embodiment of the averaging and comparison block of FIG. 1 suitable for implementation in hardware. This embodiment is based on equation Eq.3.

When a packet arrives, its length L_{P} is added in summer Σ4 to the sum ΣL of previous packet lengths since the check period started stored in the memory. If the packet is accepted, as indicated by the “packet accept/discard” signal from the packet blocking block of FIG. 1, then after delay D6, the new sum ΣL+L_{P} is written back to the memory, via the enable gate (triangle) controlled by the “packet accept/discard” signal, to overwrite the previous value ΣL in memory.

When the new packet arrives, a fraction of the old rate R_{old} value (i.e. R_{old}/2ⁿ) is also read from memory, and multiplied by the constant c. The lowest n bits of sum ΣL+L_{P} are shifted right by n bit positions to effect division by 2ⁿ and the result it multiplied by (2ⁿ−c). This product is then added to the product of R_{old}/2ⁿ and c in summer Σ5. The result of the addition represents the new rate R_{new} and this is compared with the threshold rate Rₗᵢₘ set by the management system and stored in memory. If the new rate R_{new} is less than the threshold rate Rₗᵢₘ, then the packet is within the bandwidth use threshold. The comparator produces an output indicating the result of the comparison (i.e. whether the present packet is above or below the bandwidth use threshold) which is provided to the packet blocking block of FIG. 1.

The new rate value R_{new} is divided by 2ⁿ and the result used to overwrite the old value R_{old}/2ⁿ in memory (after delay D7) when a counter driven by a clock signal to indicate the bandwidth use check period T has expired, generating signal “Exp”. When the counter T expires, signal “Exp” also clears the sum of previous packet lengths ΣL stored in the memory.

If a relatively coarse choice of smoothing factor is acceptable, then Eq. 3 can be further simplified to

$${R}_{new} = {R}_{old} + v \times ( {\sum }_{t = 0}^{T} {L}_{t} - {R}_{old} ) \qquad ( Eq . 3 a )$$

where v=1−c/2ⁿ. The smaller v is, the more smoothing is introduced. In this equation, values are chosen such that v is a negative power of two , i.e. 2^{-S} where S is an integer (S takes the value 2, 3, 4, 5, . . . , i.e. v takes the value ¼, ⅛, 1/16, 1/32, . . . ) This choice of values advantageously reduces the multiplication operation (in fact multiplying by a fraction equating to a division) to merely discarding the lowest S bits of the term shown as a bracketed difference in Eq 3a. This significantly reduces the demand for arithmetic resources and results in very cost effective hardware consisting essentially of three summers: Σ4, 5 and 5a..

The hardware implementation of Eq. 3a is shown in FIG. 4a. The difference between the operation of this circuit and the one in FIG. 4 is that the full value of R_{old} is stored, the bits of sum ΣL+L_{P} are shifted right by S bit positions to effect multiplication by v, the bits of R_{old} are read from memory and are also shifted right by S bit positions to effect multiplication by v, the product v.R_{old} is then subtracted in summer Σ5a from the product v(ΣL+L_{P}), and the difference is added in summer Σ5 to R_{old}. The result of this addition represents the new rate R_{new} which is then used exactly the same way as in Eq. 3 and FIG. 4, except that the full value of R_{new} is stored in memory. All other functions of the circuit in FIG. 4a are the same as those of the circuit of FIG. 4.

4. Packet Blocking

Where calculation of bandwidth use is carried out at fixed time intervals (as described in section 3 above and, as an option, in section 1, the averaging algorithms rely on counting bytes of accepted packets and periodic updates. This may result in the rejection of all packets received during a period from a first check identifying a breach of the threshold and the next check, irrespective of the bandwidth used during this period. Decreasing the period between checks will tend to reduce the numbers of packets rejected in this way, but will cause a corresponding increase in the processing load such that the processing and memory access performance required to support the algorithms above might need improvement, especially if they share a memory bus with other functions.

4.1. Adaptive Check Period

If the bandwidth threshold Aₗᵢₘ is defined as the number of bytes allowed per unit check period, then providing a time stamp q₀ from the clock period counter at the start of the check period and setting the number of packets N received in the period (whether accepted or not) to a predetermined value (i.e. terminating the check period on receipt of the predetermined number of packets) allows for adaptive reduction of the check period at high packet arrival rates. Hence the maximum number of packets of the user that will be accepted or blocked without re-checking the bandwidth used will be limited. Advantageously the length of the checking period will reduce at times of high packet throughput.

This transforms the smoothed average function of Equation 3 as follows:

$${R}_{new} = α {R}_{old} + ( 1 - α ) \frac{{\sum }_{t = {q}_{0}}^{{q}_{N}} {L}_{t}}{{q}_{N} - {q}_{0}}$$

where q_{N} is the value of the clock-period count q at the arrival of the last packet N. This may be transformed for ease of implementation in hardware as:

$${R}_{new} = c \times {R}_{old} / {2}^{n} + ( {2}^{n} - c ) \times [ ( {\sum }_{i = {q}_{0}}^{{q}_{N}} {L}_{t} ) / ( {q}_{N} - {q}_{0} ) ] / {2}^{n} . \qquad ( Eq . 4 )$$

This differs from Eq. 3 in the division by (q_{N}−q₀). This calculation can be implemented in hardware for about the same price as the conventional smoothed average. An advantage of the method of the present embodiment, represented by Equation 4, is the very quick response of the calculated value of R_{new} to changes in data rate during a packet burst (i.e. a large number of packets arriving in quick succession).

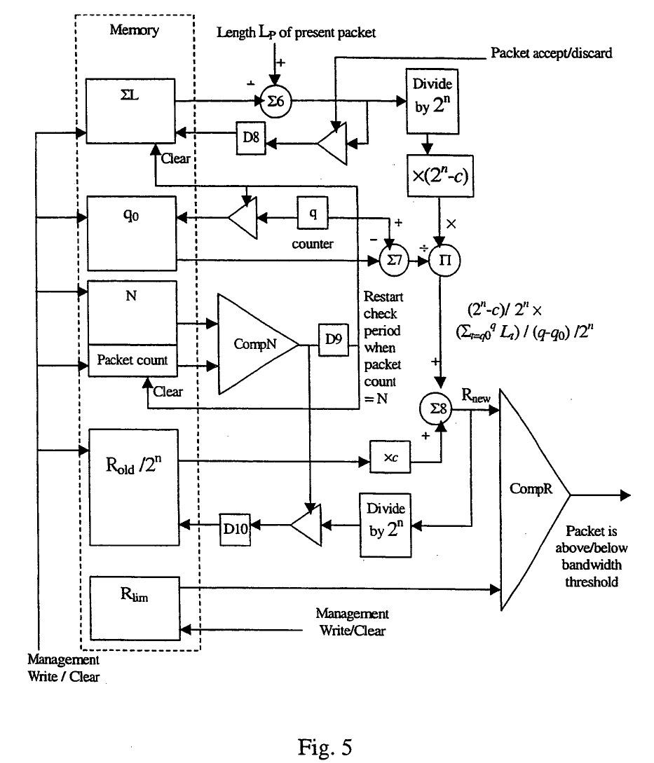

FIG. 5 shows a further embodiment of the averaging and comparison block of FIG. 1 suitable for implementation in hardware. This embodiment is based on equation Eq.4.

When a packet arrives, its length L_{P} is added in summer Σ6 to the sum ΣL of the lengths of previous packet accepted since the check period started. If the packet is not discarded by the packet blocking block of FIG. 1 (as indicated by the signal “packet accept/discard” which controls an enable gate (triangle) controlling the transmission of the sum ΣL+L_{P}) then after this addition and delay D8, the new sum ΣL+L_{P} is written back to the memory to overwrite the previous value ΣL.

When the new packet arrives, a fraction R_{old}/2ⁿ of the old rate R_{old} is also read from memory, and multiplied by constant c.

Since adaptive periods are used, the maximum packet count N is set in the memory, and a “Packet count” is implemented in the memory. When the two are equal (i.e. the packet count reaches N) this is detected by comparator CompN (e.g. bitwise exclusive OR function). The comparator output signal is delayed by delay D9 before clearing the “Packet count” and ΣL values stored in the memory and overwriting the counter value q₀ (corresponding to the start of the current checking period) held in memory by the current counter value q. The overwriting is controlled by two further enable gates (triangles) controlled by the output of comparator CompN. Thus the circuit is returned to an initial state corresponding to the start of a new checking period.

When the new packet arrives, the initial counter value q₀ of the check period is read from memory and subtracted in summer Σ7 from the current value of the counter q. The packet length sum ΣL+L_{P} is divided by 2ⁿ (e.g. by right shifting the value) and the result multiplied by (2ⁿ−c). This product is then divided in multiplier Π by the difference between the current and initial counter values (q−q₀) generated by Σ7 and the result is added in summer Σ8 to the product c×R_{old}/2ⁿ, which addition then results in a new rate value R_{new}. The new rate R_{new} is compared in comparator CompR with the threshold rate Rₗᵢₘ set in the memory by the management system. If R_{new} is less than Rₗᵢₘ, then the allocated bandwidth use threshold has not been exceeded. The comparator produces an output indicating the result of the comparison which is provided to the packet blocking block of FIG. 1.

The new rate value R_{new} is divided by 2ⁿ and the result used to overwrite (after delay D10) the old value R_{old}/2ⁿ in memory as described above and when enabled by the output of comparator CompN indicating that the packet count has reached the value N.

Advantageously, together with the adaptive check period described above, a fixed check period can be maintained in parallel.

4.2. Proportional Blocking

According to a further embodiment of the present invention, blocking words are used to implement blocking of packets on a pseudo-random basis, with one blocking word being provided per user. The blocking word contains a string of bits of selected length which are arranged to be rotated (either rotated left or right with bits shifted out from one end re-entering the blocking word at the opposite end) by a prime number of bit positions. The bit at a selected fixed location in the blocking word is tested after every packet received and if set results in the present packet being discarded. The value of this bit may change for each packet due to the rotation of the string of bits. Alternatively, the blocking word may comprise a prime number of bit locations with rotation each time by a number of bit positions different from that prime number. The choice of a prime number is preferred (although not essential) so that any bit of the string will not occupy the same position in the blocking word until rotated a number of times equal to the number of bits in the word. Rotation is effected on the arrival of each packet of the user. At the end of a check period, bits in the blocking word will be set or reset depending on the history of measured bandwidth use established in a threshold overrun log, as described below. If bandwidth use during the period of the log to date above the preset threshold is detected (i.e. overrun) then more bits will be set. If the bandwidth use so far the in the current log period is below the threshold, some bits will be reset. If the bandwidth use so far the in the current log period is equal to the threshold no bits will be changed, or some may be set or reset. Only reset bits are set, and only set bits are reset. The number of set bits is kept in memory as a binary count (Z in FIG. 6) and converted into a bit string to form the blocking word. Both the blocking word and the set bit count Z are stored (separately) with reference to the user identity. The conversion can take any form, as long as it is consistent. A preferred implementation is of the “thermometer” type i.e. with bits set/reset on only one side of the blocking word with the set bits forming a continuous block. In this case the pattern held by the blocking word would not repeat on rotation before the number of rotations equalled the number of bit positions in the word.

The present invention advantageously requires comparatively little processing and provides for rejection of individual packets on a pseudo-random basis as opposed to the rejection of a block of packets, e.g. comprising of all packets received during the check period following detection of an overrun. In particular, the present invention advantageously avoids the rejection of packets or cells in blocks that is typical of the conventional “leaky-bucket” method. The pseudo-random blocking of individual packets provided by the arrangement of the present invention is more easily tolerated by users of voice and video traffic. Proportional blocking may be implemented together with, but does not require, a changing or an adaptive check period.

If bandwidth overrun keeps on happening in subsequent check periods, this method will result in more and more bits being set in the blocking word. If overrun does not occur in subsequent check periods, the number of set bits will gradually decrease. When all bits are set in the blocking word, every packet of the user will be blocked: when no bits are set every packet of the user will be accepted.

In a further preferred embodiment, the number of bits set or reset in the blocking word in any check period is varied in proportion to the number of bytes in a check period above or below the allocated bandwidth use threshold respectively. As a further alternative, a fixed number of bits may be set or reset depending upon whether overun is detected during a check period or not. This results in simpler and cheaper hardware. Changing a fixed number of bits will tend to result in the number of packets discarded in the subsequent period changing stepwise depending on the result of the check carried out in the current period. This tendency is increased if about half the bits in the blocking word is set (statistically most likely) and the number of bits set/reset each check period is comparable to half of the Blocking Word Size.

FIG. 6 shows a hardware implementation of the packet blocking block according to a preferred embodiment of the invention. As shown in FIG. 6, when an indication that a packet has overrun the bandwidth use threshold is received from the averaging and comparison block of FIG. 1, the threshold overrun log, which is a number held in memory, is incremented by one. This is done by reading the number from the memory, adding one to it depending on the state of the “packet above/below bandwidth use threshold” signal received from the averaging and comparison block and writing the result back into the memory (overwriting the previous value). According to an alternative embodiment, the log is incremented by the length (in bytes) of the offending packet. In addition to incrementing as above, the threshold overrun log can be decremented when the averaging and comparison block indicates a packet below the threshold. As a result the log can comprise negative values. Hence a history of bandwidth use is established.

The counter of FIG. 6 defines the blocking period. In contrast, the bandwidth use check period is defined according to the various embodiments described above by the counters in the “Averaging and Comparison Block”. Hence in FIG. 4 this period is defined by the “counter with period T”, in FIGS. 2 and 5 by the comparison of the packet count with the preset value N. When the counter of FIG. 6 expires at the end of a blocking period, a signal “Exp” is generated that enables another read from the threshold overrun log via enable gate (triangle). The value read from the log controls multiplexer Mux in selecting one of two values (either a positive or a negative value) for transmission to summer Σ12. If the value of the threshold overrun log is more than zero, then the positive value is selected (either a preset number G or a value for G generated by scaling (multiplying) the log value by a scaling factor g). If the threshold overrun log value read is equal to or less than zero then the negative value is selected (either a preset number −G or a value for −G is generated by scaling (multiplying) the negative log value by the scaling factor g). It will be apparent that, in the case of a zero log value, the “negative value” could in practice also equal zero.

The number Z of bits set in the blocking word is kept (in binary integer form) in memory and read when the central counter expires at the end of the blocking period (signal “Exp” controlling an enable gate (triangle) for transmission of Z to summer Σ12). The value G or −G is then added to Z in summer Σ12 and the result Z_{new} written back to the memory to overwrite the old value of Z (after delay D15). If the new value of Z is negative, then Z is set to zero in the memory.

The new value of Z is also written to the memory location storing the blocking word. Before it is written here, the value of Z is converted to a long (say 64 bit) word that contains the number of set bits indicated by Z.

When a new packet arrives, this blocking word is read, rotated, by a prime number of bits and written back into the memory to overwrite its old value. A selected fixed bit location of this blocking word (say bit 0) is used to control the state of output signal “packet accept/discard”. If this bit is set, it indicates the present packet is to be discarded. If this bit is not set it indicates that the present packet is to be accepted. The signal “packet accept/discard” is updated when the “packet arrived” signal is valid.

The above methods may be implemented in hardware as described above with reference to the drawings.

Where reference is made above to a “packet” this includes an internet protocol layer 3 packet and, alternatively, a layer 2 frame. The present invention is not limited to internet protocol systems but applies equally to any communications system in which bandwidth use policing is desirable, and in particular to those with bursty traffic.

All the various quantities in all the implementations can be stored in different physical memories, or can use different locations in a single memory at addresses related to the User or Call identity. All memory can be modified and/or cleared by the management system. The delays “D”, as shown in the drawings denote that the write to, or clearing of (as the case may be) the memory takes place after the corresponding read. In the figures, the delay elements (“D”) may be merged with other delays of the implementation, they are shown as discrete elements to indicate the time sequence of operations. In the figures, all enable (triangle) elements may be implemented either as an enable logic or as logic (typically controlled by a state machine) that performs the corresponding operation when appropriate (i.e. “operation enabled”) and does not perform it when not appropriate (i.e. “operation disabled”). Instead of counting bytes of a packet, the byte count value in the header of each packet may advantageously be detected and used in the above calculations. References to “summers” (also known as “adders”) include the functions of addition and subtraction, as appropriate.

The value of packet count N may be chosen depending on the type of traffic in order to yield a reliable indication of bandwidth use in the shortest practical time. For voice traffic a value in the range 40 to 60 is preferred, whereas for video or data traffic a value in the range 80 to 300 is preferred.

A value for n in FIGS. 4 or 5 equal to 5, i.e. so that 2ⁿ takes the value 32 and a value for c in the range 26 to 30 yields a value for α in the preferred range of 0.8 to 0.95. Preferred counter periods are as follows: the check period (if fixed) of the Averaging and Comparison Block of the order of one second, the blocking period of the Packet Blocking Block of the order of ten seconds.

1. A communications system for the communication of traffic of a plurality of users in which the system has a finite bandwidth for carrying the traffic;
in which the system comprises policing means for monitoring the bandwidth use of each of the users;
in which the policing means comprises bandwidth use averaging means implemented in hardware for calculating an average value of bandwidth use per user.

2. The system as claimed in claim 1 in which the averaging means is arranged to process exclusively integer values.

3. The system as claimed in any one of claims 1 and 2 in which the averaging means comprises arithmetical functions exclusively comprising one or more adders and multipliers.

4. The system as claimed in any one of claims 1 and 2 in which the averaging means comprises one or more division functions in which the or each division function is implemented by means of decreasing the significance of each bit of the quantity to be divided.

5. The system as claimed in any one of claims 1 to 4 in which the averaging means comprises means for generating an average value of bandwidth use per user over each of a succession of time periods of variable duration.

6. The system as claimed in claim 5 in which the traffic is divided into packets and in which the duration of each time period is determined by the arrival of a set number of packets.

7. The system as claimed in claim 6 in which the set number of packets lies in the range from 40 to 60 for voice traffic.

8. The system as claimed in any one of claims 6 and 7 in which the set number of packets lies in the range from 80 to 300 for video and/or data traffic.

9. The system as claimed in any above claim in which the policing means comprises packet discard means for discarding packets in a pseudo-random fashion.

10. The system as claimed in claim 9 in which the packet discard means comprises means for recording the history of bandwidth use by each user; in which the probability that a packet of a particular user will be discarded depends on the history of bandwidth use by the user.

11. The system as claimed in any one of claims 9 and 10 in which the packet discard means is implemented in hardware.

12. The system as claimed in claim 11 in which the discard means comprises a shift register per user and means to set one or more bits of a shift register if bandwidth use by the associated user above a set level has been detected by the policing means;
and in which the discard means comprises means to reset one or more bits of the shift register if bandwidth use by the user below a set level has been detected by the policing means.

13. The system as claimed in claim 12 in which the packet discard means comprises rotate means for rotating the contents of the shift register.

14. The system as claimed in claim 13 in which the rotate means is effective for rotating the contents by a prime number of bit positions.

15. The system as claimed in any one of claims 12 and 13 in which the shift register comprises a prime number of bit positions.

16. The system as claimed in any above claim in which the averaging means is comprised in a firewall.

17. A method of policing bandwidth use in a communications system for the communication of traffic of a plurality of users in which the system has a finite bandwidth for carrying the traffic;
the method including the steps of monitoring the bandwidth use of each of the users and generating in hardware an average value of bandwidth use per user.

18. The method as claimed in claim 17 in which the system comprises a counter for counting clock periods (dτ), in which the counter produces initial (q₀ ) and final (q) count values, respectively at the start and end of the measurement period (T); the method including the step of measuring bandwidth use over a measurement period (T) and comparing the measured bandwidth use with an imposed limit for bandwidth use in accordance with the relationship:
$${\sum }_{t = {q}_{0} d τ}^{qd τ} {L}_{accepted} {=}_{compare} ( q - {q}_{0} ) {A}_{lim} \qquad ( Eq 1 )$$
where L_{accepted} is the length of a packet accepted from the user during the measurement period (T) and Aₗᵢₘ is the imposed limit for average bandwidth use.

19. The method as claimed in claim 17 in which the system comprises a counter for counting clock periods, in which the counter produces count values (q) corresponding to the time of arrival of each packet of a user; the method including the steps of measuring the elapsed time between successive received packets of the user, measuring the length of each of the packets and comparing the measured length with an imposed limit for packet length in accordance with the relationship:
$$L ( last . packet ) {=}_{compare} ( {q}_{pres} - {q}_{last} ) {A}_{lim} , \qquad ( Eq 2 )$$
where qₗₐₛₜ is the count value at the arrival of the last packet, qₗₐₛₜ is the count value at the arrival of the present packet, L_{last.packet} is the length of the last received packet and Aₗᵢₘ is the imposed limit for average bandwidth use.

20. The method as claimed in claim 17 in which a smoothed average value of data rate (R_{new}) over a measurement period (T) is generated in accordance with the relationship:
$${R}_{new} = c \times {R}_{old} / {2}^{n} + ( {2}^{n} - c ) \times ( {\sum }_{t = 0}^{T} {L}_{t} ) / {2}^{n} \qquad ( Eq 3 )$$
where α is a smoothing factor and c is equal to α divided by 2ⁿ, where n is an integer, R_{old} is the previous value for data rate, L is the length of a packet received at time t during measurement period (T).

21. The method as claimed in claim 17 in which a smoothed average value of data rate (R_{new}) over a measurement period (T) is generated in accordance with the relationship:
$${R}_{new} = {R}_{old} + v \times ( {\sum }_{i = 0}^{T} {L}_{t} - {R}_{old} ) \qquad ( Eq 3 a )$$
where v is a negative integer power of two, R_{old} is the previous value for data rate and L is the length of a packet received at time t during measurement period (T).

22. The method as claimed in claim 17 including the step of generating a smoothed average value of data rate (R_{new}) over a preset number of packets (N) in accordance with the relationship:
$${R}_{new} = c \times {R}_{old} / {2}^{n} + ( {2}^{n} - c ) \times [ ( {\sum }_{t = {q}_{0}}^{{q}_{N}} {L}_{t} ) / ( {q}_{N} - {q}_{0} ) ] / {2}^{n} , \qquad ( Eq 4 )$$
in which the system comprises a counter for counting clock periods, in which the counter produces an initial value (q₀ ) on receipt of the first packet and a final value (q_{N}) on receipt of the last packet; in which α is a smoothing factor and c is equal to α divided by 2ⁿ, where n is an integer, R_{old} is the previously generated value of data rate, Lₜ is the length of a packet received at time t during the measurement period.

23. The method as claimed in claim 17 including the step of processing exclusively integer values.

24. The method as claimed in any one of claims 17 and 23 including the step of generating an average value of bandwidth use per user over each of a succession of time periods of variable duration.

25. The method as claimed in claim 24 in which the traffic is divided into packets, the method including the steps of counting the packets of each user received and determining the duration of each time period on the basis of the relevant packet count.

26. The method as claimed in any one of claims 17 to 25 including the steps of recording the history of bandwidth use by each user and discarding packets in a pseudo-random fashion; in which the probability that a packet of a particular user will be discarded depends on the history of bandwidth use by the user.

27. The method as claimed in claim 26 in which the system comprises packet discard means in which the discard means comprises a shift register per user, the method including the steps of comparing bandwidth use by each user with a preset level, setting one or more bits of a shift register if bandwidth use by the associated user above the preset level is detected and resetting one or more bits of the shift register if bandwidth use by the user below the preset level is detected.

28. The method as claimed in claim 27 including the step of rotating the contents of the shift register.

29. The method as claimed in claim 30 including the step of rotating the contents by a prime number of bit positions.

30. The method as claimed in Claim any one of claims 29 and 30 in which the shift register comprises a prime number of bit positions.

31. The method as claimed in any in any one of claims 17 to 30 in which the hardware is comprised in a firewall.

32. A communications system for the communication of traffic of a plurality of users in which the system has a finite bandwidth for carrying the traffic;
in which the system comprises policing means for monitoring the bandwidth use of each of the users;
in which the policing means comprises packet discard means for discarding packets in a pseudo-random fashion.

33. A communications system for the communication of traffic of a plurality of users in which the system has a finite bandwidth for carrying the traffic;
in which the system comprises policing means for monitoring the bandwidth use of each of the users;
in which the policing means comprises packet discard means for discarding packets on an individual basis.

34. The system as claimed in any one of claims 32 and 33 in which the packet discard means comprises means for recording the history of bandwidth use by each user; in which the probability that a packet of a particular user will be discarded depends on the history of bandwidth use by the user.

35. The system as claimed in any one of claims 32 to 34 in which the packet discard means is implemented in hardware.

36. The system as claimed in claim 35 which the discard means comprises a shift register per user and means to set one or more bits of a shift register if bandwidth use by the associated user above a set level has been detected by the policing means;
and in which the discard means comprises means to reset one or more bits of the shift register if bandwidth use by the user below a set level has been detected by the policing means.

37. The system as claimed in claim 36 in which the packet discard means comprises rotate means for rotating the contents of the shift register.

38. The system as claimed in claim 39 in which the rotate means is effective for rotating the contents by a prime number of bit positions.

39. The system as claimed in any one of claims 36 and 37 in which the shift register comprises a prime number of bit positions.

40. The system as claimed in any one of claims 32 to 39 in which the packet discard means is comprised in a firewall.

41. A method of policing bandwidth use in a communications system for the communication of traffic of a plurality of users in which the system has a finite bandwidth for carrying the traffic; the method including the steps of monitoring the bandwidth use of each of the users and discarding packets in a pseudo-random fashion.

42. The method as claimed in claim 41 including the steps of recording the history of bandwidth use by each user, in which the probability that a packet of a particular user will be discarded depends on the history of bandwidth use by the user.

43. The method as claimed in any one of claims 41 and 42 in which the system comprises packet discard means and in which the discard means comprises a shift register per user, the method including the steps of comparing bandwidth use by each user with a preset level, setting one or more bits of a shift register if bandwidth use by the associated user above the preset level is detected; and resetting one or more bits of the shift register if bandwidth use by the user below the preset level is detected.

44. The method as claimed in claim 43 including the step of rotating the contents of the shift register.

45. The method as claimed in claim 44 including the step of rotating the contents by a prime number of bit positions.

46. The method as claimed in any one of claims 43 and 44 in which the shift register comprises a prime number of bit positions.

47. The method as claimed in any in any one of claims 41 to 46 in which the packet discard means is comprised in a firewall.
